(19) United States
(12) Patent Application Publication
(10) Pub. No.: US 2002/0116644 A1
(43) Pub. Date: Aug. 22, 2002

(54) Adapter card for wirespeed security treatment of communications traffic

(75) Inventor: Christian Richard, Dorval (CA)

Correspondence Address: MERCHANT & GOULD PC, P.O. BOX 2903, MINNEAPOLIS, MN, 55402-0903, US

(73) Assignee: Galea Secured Networks Inc., Blainville, QC (CA)

(21) Appl. No.: 10/060,971

(22) Filed: Jan. 30, 2002

Related U.S. Application Data
(60) Provisional application No. 60/264,989, filed on Jan. 30, 2001.

(51) Int. Cl. H04L 9/00

(52) U.S. Cl. 713/201; 713/150

(57) ABSTRACT

An adapter card operatively coupled to an internal bus of a host computer including a host bus, for wirespeed security treatment of communications traffic is disclosed. The card includes a network controller for communicating with clients on said network; a memory for storing data and code, where the code includes a high speed load handler application for controlling I/O, DMA, the host bus, a system bus and at least one communications port; a processing unit coupled to the memory for executing the code; a protocol adapter coupled to the processing unit, and adapted to couple to the host bus, for communicating with the host computer; where the processing unit is adapted to exploit unused resources of the host computer when resources on the adapter card are saturated. The card includes its own TCP/IP stack, and overrides the operating system of the host. Thus, communication between the host and the card can be effected through the bus with risking a security breach. The card also preferably includes a plurality of specialized processors, which are adapted to perform specific tasks, such as security, encryption, VPN, SSL, etc. The card is particularly adapted for high speed treatment of information.

### FIELD OF THE INVENTION

The present invention concerns an adapter card for wirespeed treatment of communications traffic in a network. In the present description, the expression “wirespeed” is meant to designate a high bit rate, i.e. over 10 Mbit/sec. The card of the present invention is thus adapted to perform firewalling functions, as well as other functions, for high speed networks, without creating bottlenecks.

### DESCRIPTION OF THE PRIOR ART

Network security technologies were introduced in the early 1960s, when IBM introduced the first firewall. Back then, a firewall was a simple piece of software forbidding events caused by elements (programs or data) coming in through the modem line. Even if computers were much slower at the time, as modem lines speeds were only of the order of a hundred bits/sec, the main processor had no problem to keep up with the data flow.

Today, although computing power has increased by several orders of magnitude, communication speeds have increased even more rapidly, but the main principles behind existing software firewalls are the same, and specifically they still run on the server processor (see FIG. 1—Prior Art). As a result, and considering that threats are growingly complex and difficult to detect, firewalls tend to create huge bottlenecks in networks carrying even moderate traffic loads by today's standards.

As an example, with the introduction of network infrastructure capable of terabyte capacity, security products need to process traffic flows of at least 10 Gbit/s. In practice, this not only entails being able to keep up with such enormous data rates, and associated transactions, but also to be able to handle a very large number of concurrent sessions, as, depending of the configuration of the network, data flows do not usually originate from only one or a few servers but from all, or almost all, of the servers at the same time. A good rule of thumb to follow, for a server operating within a terabyte infrastructure, would be to be able to handle at least one million concurrent sessions, and process at least ten to one hundred thousand transactions per second.

Such firewalling and encryption/decryption performance is simply not achievable with the present processing power available in network servers. Furthermore, even if technologically smarter software approaches could be developed, it simply would not make sense, from an efficiency point of view, to use the server processor to perform security functions during most of the time as this would entail that all the other tasks that the processor would have to accomplish would be significantly slowed down anyway, resulting in other types of bottlenecks.

To overcome the shortcomings of pure software architectures to network security, a method based on a hardware approach was proposed during the last few years. It consists in introducing a serial, stand-alone, computer-based appliance performing firewalling functions between the network and the server. (see FIG. 2—Prior Art)

This approach not only achieves a far better performance than traditional software approaches, but it also increases security by introducing a level of physical isolation between the server processor and the network. Consequently, should a hacker wish to attack the server, it would have to successfully hack the appliance processor and discover the details of communications between the two processors, including specific encryption, greatly complicating the task.

However, this approach also presents some fundamental limitations, which, as networks expand and data rates increase, will eventually prevent it from keeping up with the needs. These fundamental shortcomings are the following:

a) Presently, devices based on the aforementioned approach take care only of firewalling functions. In theory, they could also be used for application level encryption/decryption purposes but they are not, basically because considerably more processing power would be needed. Furthermore, with such a configuration, there are no particular technological benefits to transferring this task to the device, as opposed to having the server still performing it.

b) A serially inserted device can rely only on its processing power and cannot have access to the processing power of the server computer when, for whatever reason, it is under-used.

c) Over and above pure processing power, available memory is also an issue, as the handling of a large number of sessions involves the usage of considerable memory. Now, a serially inserted device can rely only on its on-board memory and cannot have access to the unused portions of the server's memory.

### SUMMARY OF THE INVENTION

It is an object of the present invention to provide a network security card which can perform security functions including firewalling functions, and advantageously, encryption functions, at wirespeed. In accordance with a first aspect of the invention, this object is achieved with an adapter card operatively coupled to an internal bus of a host computer including a host bus, for wirespeed security treatment of communications traffic, said adapter card comprising:

a network controller for communicating with clients on said network;

a memory for storing data and code, where said code includes a high speed load handler application for controlling I/O, DMA, the host bus, a system bus and at least one communications port;

a processing unit coupled to said memory for executing said code;

a protocol adapter coupled to said processing unit, and adapted to couple to said host bus, for communicating with said host computer;

wherein:

said processing unit is adapted to exploit unused resources of the host computer when resources on the adapter card are saturated.

In accordance with a second aspect of the invention, this object is achieved with an adapter card operatively coupled to an internal bus of a host computer including a host bus, for wirespeed security treatment of communications traffic, said adapter card comprising:

a network controller for communicating with clients on said network;

a memory for storing data and code, where said code includes a high speed load handler application for controlling I/O, DMA, the host bus, a system bus and

at least one communications port;

a processing unit coupled to said memory for executing said code;

a plurality of specialized processors; and

a protocol adapter coupled to said processing unit, and adapted to couple to said host bus, for communicating with said host computer.

In accordance with a third aspect of the invention, this object is achieved with an adapter card operatively coupled to an internal bus of a host computer including a host bus, for wirespeed security treatment of communications traffic, said adapter card comprising:

a network controller for communicating with clients on said network;

a memory for storing data and code, where said code includes a high speed load handler application for controlling I/O, DMA, the host bus, a system bus and at least one communications port;

a processing unit coupled to said memory for executing said code;

a protocol adapter coupled to said processing unit, and adapted to couple to said host bus, for communicating with said host computer;

wherein:

said adapter card further includes an IP stack.

In accordance with a fourth aspect of the invention, this object is achieved with an adapter card operatively coupled to an internal bus of a host computer including a host bus, for wirespeed security treatment of communications traffic, said adapter card comprising:

a network controller for communicating with clients on said network;

a memory for storing data and code, where said code includes a high speed load handler application for controlling I/O, DMA, the host bus, a system bus and

at least one communications port;

a processing unit coupled to said memory for executing said code;

a plurality of specialized processors;

a protocol adapter coupled to said processing unit, and adapted to couple to said host bus, for communicating with said host computer;

wherein:

said processing unit is adapted to execute up to Layer 7 security functions.

### BRIEF DESCRIPTION OF THE DRAWINGS

The present invention and its advantages will be more easily understood after reading the following non-restrictive description of preferred embodiments thereof, made with reference to the following drawings in which:

FIG. 1 identified as Prior Art is a schematic representation of a security configuration for a server;

FIG. 2 identified as Prior Art is a schematic representation of a security configuration using a serially inserted device;

FIG. 3 is a schematic representation of a network security card according to a preferred embodiment of the invention;

FIG. 4 is a schematic representation of the Level 7 security function;

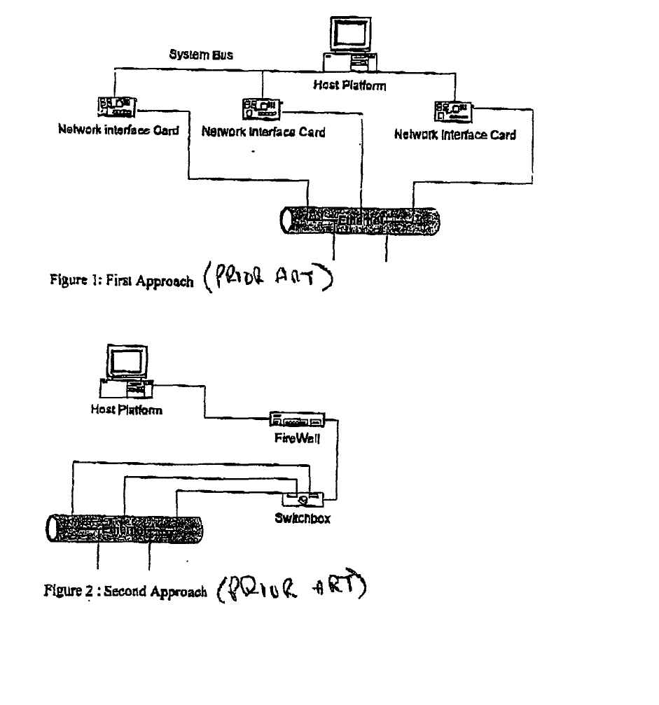

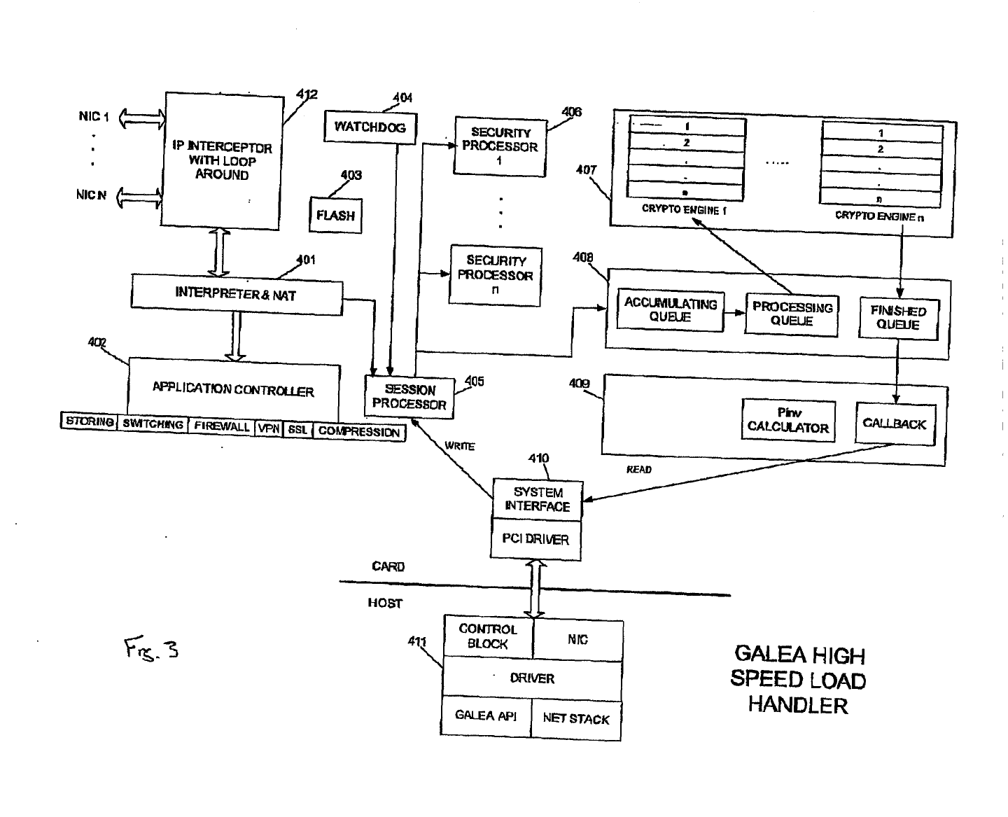

### DESCRIPTION OF A PREFERRED EMBODIMENT OF THE INVENTION

The present invention describes a novel approach for computer network security based on a network security card combining the following functions:

a) network interfacing,

b) firewalling,

c) encryption/decryption acceleration, both for SSL and VPN applications,

d) Layer 7 filtering.

The major innovation associated with this approach consists in an architecture design of the aforementioned network card whereby the data path runs “in parallel” with the host computer, which can be a network server or gateway operating system or a workstation. This unique approach allows the replacement of the IP stack of a host by the one of the operating system running on the network security card processor.

Compared to standard firewall approaches, this results in various important technological benefits, of which the most important are:

a) Logical isolation of the host from the network is achieved;

b) Surplus resources of the host machine remain available for security processing tasks;

c) Malicious attacks and denials of service can be stopped without perturbing the operation of the host;

d) Achieving compatibility with various operating systems is a firmware issue only;

e) Secure storage of encryption key(s) is possible in a wirespeed environment.

The present invention describes a new alternate approach, capable of overcoming the limitations identified in the background, and intelligently combining the old, purely-software based approach, with the newer mainly hardware-based approach.

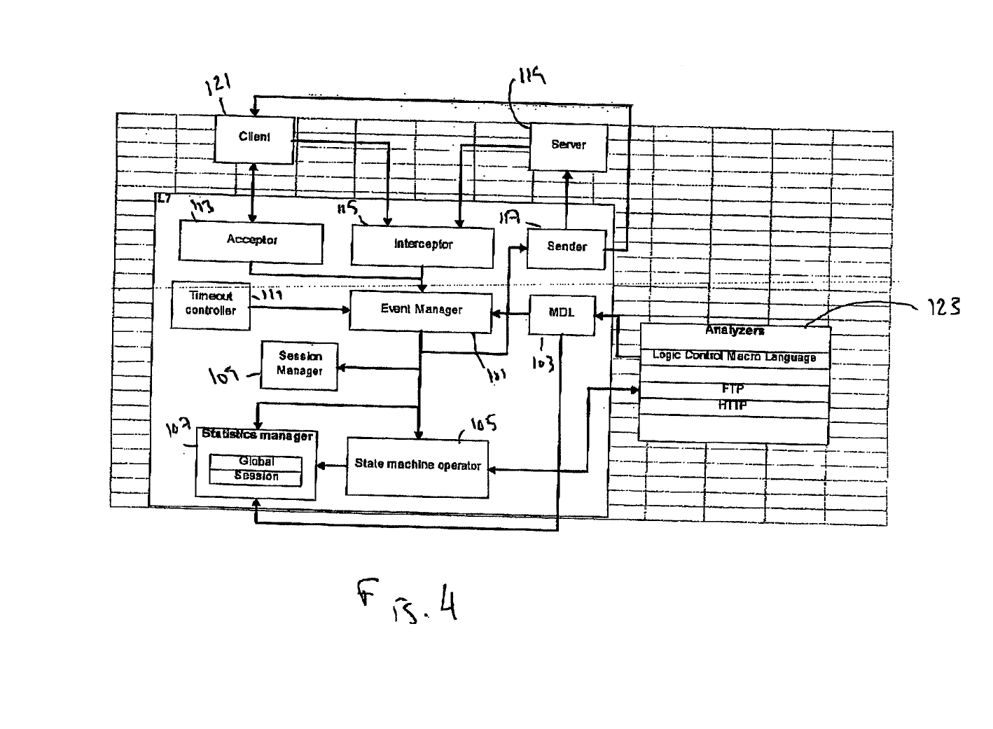

The present invention, schematically illustrated in FIG. 3, consists in a hardware board or drop-in card, or network interface card (the terms are used interchangeably in the present description), which performs network interfacing, firewalling, layer 7 filtering, compression/decompression and encryption/decryption functions, as opposed to only firewalling. It is physically connected inside the host computer as a plug-in card, but logically connected “in parallel” with the host computer. The card is equipped with its own intelligence and memory, but can nevertheless communicate with the host processor through multiple accesses to the system busses.

The advantages of this approach are the following:

a) As the card can communicate with the host processor through the system bus, it can also use all the host processor surplus processing power and memory to improve the execution of security tasks. However isolation is retained, as, in the accomplishment of security tasks, the card processor acts as the “master” and the host processor as the “slave”. This is actually implemented by replacing host processor IP stack with the security board processor IP stack. Consequently, even if a hacker could find a way of examining the code running on the server as well as the memory content, that information would be incomplete and consequently it would still be impossible to break security.

b) System upgrades to achieve higher throughput and number of connections handled can be done by replacing the security card with one with higher memory addressing capability and/or adding bus accesses, and by installing additional memory in the host. Actually, increased processing power on the card or on the host would not be necessary if one of the two was underused. In fact, card replacement is not even necessary if future expansion is planned since the beginning. As extra addressing capability and additional bus accesses affect the cost of a card only marginally, upgrade planning increases costs only by a minimal amount. Furthermore, it is reasonable to expect the cost of memory to keep on decreasing in the future, and planning a future expansion makes more sense than actually implementing an over-designed system. Such a solution cannot be applied to traditional software-based firewalls. It cannot be applied either to the previously described “serial” approach, as, even if additional memory is installed in the server, little or no performance benefits might result. In particular, if the bottleneck is caused by either the memory or the processing power of the serial hardware firewall device, or even by the processing power of the host, the resulting system will still be limited to the previous performance. Moreover, the security appliance being a totally separate unit, with its own case, power supply, wiring, etc., replacing it is a more expensive proposition than replacing a simple plug-in card. Finally, with such a configuration, network cards would still need to be replaced to achieve a capacity expansion.

c) Because of its unique “parallel” configuration, the proposed approach will not cause slowdowns when a packet or a connection is dropped or otherwise refused for whatever reason, as long as the incoming data can be processed by the security card faster than the host can process incoming data. This is not the case with a software firewall, as the same processor would have to handle security over and above all the other duties. However, even for the “serial” approach, a delay would probably be observed, even if the security appliance processed data faster than the host. This is due to the fact that, unlike what happens in the “parallel” approach, the host processor still needs to do encrypting and decrypting, and relay alarms related to these activities to the security device.

d) The main operation principle of the security plug-in card proposed specifically consists in overriding the host machine operating system for its internal operations. Consequently, the card can be adapted purely by firmware changes to any host machine operating system, as long as the standard bus it was designed for (PCI, USB, etc.) is available. This truly unique characteristic is not shared with the other two approaches described previously.

The security card according to the present invention consists preferably of a Reduced Instruction Set Computer (RISC) Micro-Processor Unit (MPU) that can process the network data coming from the fast Ethernet controller, but it should be understood that it is not limited to this precise configuration. The MPU has a direct access to the acceleration module to enable fast data encryption and decryption of Secure Socket Layer (SSL) or Virtual Private Network (VPN) transactions. The system bus controls the access to either Random Access Memory (RAM), Read Only Memory (ROM), Ethernet chip, acceleration module or host system bus. It should also be understood that the MPU could be replaced by a hard-wired processor, such as an FPGA.

Ethernet Interface

In a traditional ethernet network system, incoming traffic is first processed by a NIC (Network Interface Card), directly connected on the system bus of the server. Since this incoming traffic is not isolated from the system itself, there is always the risk of intrusion from the outside. Also, it may be possible to hook an undesirable piece of software as a replacement of the original ethernet packet handler at the source, leading to the bypassing of the security software running within the server.

The proposed security card integrates the ethernet interface and the security processing, and thus it becomes impossible to hack the ethernet packet handler at the source. Once the packet has been received by the ethernet packet handler, the internal IP stack of the security board intercepts each incoming packet, processes, decrypts and analyzes it, and decides on its validity according to pre-established rules before allowing it to reach the host system bus. If the security card IP stack processor detects an undesirable intrusion, “bad” packets are immediately dropped and the connection is destroyed.

By performing these operations, the security card introduces a powerful isolation layer, preventing the insertion of an undesirable piece of software on the incoming data path.

Firewall Protection

The firewall protection allows the filtering of incoming packets depending on their origin, performs packet stateful analysis and protects the host server against malicious attacks. Again, the approach proposed presents the advantage of having the firewall protection performed on an external physical device, while still having access to internal resources.

Filtering and Packet Stateful Analysis

As a packet of data is transmitted to the security card from the ethernet interface, the packet is read and a connection context is located. If this packet is the first of a new connection, and no information is available because a connection never existed before, the analysis engine makes sure that the packet is a valid one before creating the connection.

If the packet is valid, the connection is enabled and a table entry is created to collect data about the connection. If the packet is not valid, it is dropped and no connection is opened. However, even if the connection already exists, the analysis engine compares the received packet with the information that it has collected so far. If the packet matches the expected traffic pattern, it is then forwarded to the host system network. If the packet does not match the expected traffic pattern, it is immediately dropped.

After a packet is allowed to proceed, the data in the connection table is updated with the new context information.

The above-described method is actually more sophisticated than the ones generally used. In fact, traditional packet filtering analysis processes evaluate packets using pre-established packet filtering rules, sometimes perform port evaluation specifically when there is TCP or UDP traffic, but do not evaluate the connection context of packets. On the contrary, the stateful analyzer of the present invention not only evaluates a packet based on the packet filtering rules that were specified, but also compares it to the context of related traffic. If the stateful analyzer determines that the packet matches the filtering rules, but does not match the context at that time, it can deny access. Consequently, stateful analysis expects the traffic to follow a specific logic and thus leaves very little room for hackers to break into the host machine or disrupt its operation. This feature enables the card of the present invention to perform security functions up to layer 7. This module is basically an interceptor/redirector that performs data analysis at the application layer (i.e. at the data stream level, and not at the packet level). This presupposes that packet level inspection and NAT (network address translation) is done directly on the network interface card of the present invention.

The base of this module is a state automation machine and the control logic for each analyzer will reside in a separate library, allowing customization. In order to simplify the implementation of this module, a pseudo-language definition library (MDL) is built. This library contains, in a preferred embodiment, the following macros:

PASS

DROP

FAIL

ERROR

SUCCESS

LOG

ALERT

SWITCHSTATE

STARTWITH

CONTAINS.

The requirements of the module is that data transfer should be as fast as possible, and must not consume all the CPU resources, thus avoiding endless loops without wait functions of mutexes. The overall architecture of the module is shown in FIG. 4.

As it can be appreciated, the Event manager 101 is the main thread of the module. Its synchronization will be based on mutexes, so it will only wake up when an event occurs. The event manager 101 takes care of receiving events (READ, WRITE, SESSION, TIMEOUT, . . .); handling events (READ, SESSION, TIMEOUT, . . .); managing the event queue (PostEvent( ), GetEvent( )); managing interceptor threads and generating statistics.

The acceptor thread 113 will handle new connections and post a SESSION event to create a new session. Its synchronization is based on the accept function, and thus it relies on the efficiency of the accept function in terms of CPU usage.

The interceptor thread 115 handles all incoming data (from both the client and server side). Its synchronization is based on the select function. Upon data arrival, it will read it, put it in the right session, and post a READ event.

The sender thread 117 takes care of sending data out to the appropriate destination. Its synchronization is based on mutex in coordination with the event manager.

The state machine operator (SMO) 105 is responsible for activating custom state machine operations located in the module. It will also generate statistics.

The MDL will handle most SMO results, post WRITE events and generate statistics.

Based on the options selected by the user, the module will accept or deny packets, thereby increasing the security of the system.

Denial of Service Attacks

Over and above malicious intrusion attempts it is important to fight Denial of Service Attacks (DOS). These attacks can affect systems from a mere use of resources to a more disturbing freeze and all the way to a complete crash of the server. The firewall protection system of the security card can detect and handle all known DOS attacks, which is not the case of the software firewalling approaches, thanks to the additional isolation layer introduced between the network and the host server machine.

Acceleration Module

Software applications that require a high level of security, such as LAN, WAN and E-commerce, benefit from the use of a cryptographic engine on an external card. When security functionality is centralized onto a hardware-based crypto accelerator, as opposed to the network system server's itself, the system as a whole becomes more secure. This is due to the fact that the dedicated hardware can physically protect cryptographic keys and sensitive data, and ensure correct implementations of security algorithms. The security card uses Cryptoki PKCS#11, the cryptographic API standard (Application Programming Interface) proposed by RSA. This standard includes session management and software function calls allowing the handling of any type of security objects, such as secret key, public key, certificate and digital signature. Requests for key creation/deletion, encryption/decryption and digital signature verification are fully supported. These functions are performed at a level isolated from the host network system to provide the maximum of security by manipulating security keys and data externally.

The security card enables the acceleration of most common protocols used within today's secured network data transfer for Secure Socket Layer (SSL) and Virtual Private Network (VPN), and in particular:

SSL (Secure Socket Layer, Used by all eCommerce servers)

SET (Secure Electronic Transaction for Payment system)

TLS (Issued from SSL V3 but more generic)

IPSec/IKE (Virtual Private Network)

S/WAN (Free or commercial IPSec & IKE under Linux & Unix)

Although a general functional description of the card has been done above, what follows, in reference to the accompanying drawings, is a detailed description of the components of the card and their interaction.

Referring now to FIG. 3, the card 400 of the present invention includes an IP interceptor 412 (or network controller). The function of the interceptor is to validate if the incoming packet from various NIC interfaces are valid for the card 400. If they are not, they will be dropped. Another function of the interceptor is to loop around between the NICs packets that are in transit. This allows for a very fast VPN connection.

If a packet is validated by the interceptor, it is then transferred to the interpreter 401. Its function is to apply filtering rules (as defined by the user or system administrator), which are pre-loaded in the card by the system manager through the host driver 411. If the packet is deemed acceptable by the interpreter, it will notify the session processor 405 that a session needs to be created. The interpreter also applies NAT to the packets.

It is the session processor 405 (processing unit) which forms the core of the card of the present invention. This processor 405 permits multi-traffic in the card, by assigning to each transaction a session number, which allows for queuing and for resource allocation between the other, specialized processors on the card.

The packet is then transferred to the appropriate application controller 402. It should be noted that VPN and compressed traffic is coded and can be readily recognized by the card. SSL traffic is normally assigned to a specific port in the server function. Consequently, it is all other traffic which proceeds first through the firewall function on the card. The application controller adds to the session number an identifier, identifying the type of traffic for proper routing within the card's internal resources.

For example, if the traffic is encrypted, it will be sent to cryptoengine block 407 through the high-speed queuing and assignment software module 408. It should be noted that many cryptoengines can be present on the card, either as a stand-alone module or part of an FPGA array. Furthermore, each cryptoengine consists of a plurality of discrete processors. The card is adapted to perform load sharing between each of these discrete processors, in order to maximize efficiency of the card.

Arbitration of the available resources is done by the system interface 410 (protocol adapter). The interface controls the internal bus on the card, as well as communication with the host through the appropriate communication channel, such as a PCI bus.

As mentioned previously, the card includes a firewalling function, which is located within the security processors 406. This processor can be a hard-wired FPGA, an ASIC, or a conventional processor, depending on the required speed and number of sessions to be handled simultaneously. As a note, it is the security processors which are adapted to handle denial of service attacks.

One advantage of the card of the present invention is that encryption keys can be stored in the flash memory 403. Advantageously, the encryption keys are broken up into a plurality of pieces, each of which is stored in a different area of the flash memory. This feature increases the security of the card of the present invention, and consequently the security of the network protected by the present invention.

An advantageous module which is present on the card is the callback module 409. This module is used as a flip-flop gate to let the system interface 410 know that the encryption processors 407 are idle. In a high speed system such as the one presently described, one does not have the time to perform hand-shaking between the various components. In order to avoid resource conflict, the card of the present invention monitors when a transaction is complete and requests for further operation. If an error has occurred in the processing, an error calculator sends a signal to the system interface 410 allowing for a request from the server client to resubmit its information, or for the queue to be cleared if the queuing system can be used.

As is usual in such devices, a host driver 411 contains the interface to the host computer, which can also be used to communicate with a host resident or a remote user interface. The host driver also permits the card of the present invention to have access to the host resources if the card resources are fully utilized.

Furthermore, over and above flash memory, the card 400 includes RAM, ROM, and other appropriate types of memory for storing data and code.

Although the present invention has been explained hereinabove by way of a preferred embodiment thereof, it should be pointed out that any modifications to this preferred embodiment within the scope of the appended claims is not deemed to alter or change the nature and scope of the present invention.

1. An adapter card operatively coupled to an internal bus of a host computer including a host bus, for wirespeed security treatment of communications traffic, said adapter card comprising:
a network controller for communicating with clients on said network;
a memory for storing data and code, where said code includes a high speed load handler application for controlling I/O, DMA, the host bus, a system bus and at least one communications port;
a processing unit coupled to said memory for executing said code;
a protocol adapter coupled to said processing unit, and adapted to couple to said host bus, for communicating with said host computer;
wherein:
said processing unit is adapted to exploit unused resources of the host computer when resources on the adapter card are saturated.

2. An adapter card according to claim 1, wherein said card further includes a data encryption module.

3. An adapter card according to claim 1, wherein said card further includes a data compression module.

4. An adapter card according to claim 1, wherein said card further includes an SSL module.

5. An adapter card according to claim 1, wherein said card further includes a VPN module.

6. An adapter card according to claim 1, wherein said card further includes an SSL module and a VPN module.

7. An adapter card according to claim 1, wherein said card further includes a plurality of dedicated processors.

8. An adapter card operatively coupled to an internal bus of a host computer including a host bus, for wirespeed security treatment of communications traffic, said adapter card comprising:
a network controller for communicating with clients on said network;
a memory for storing data and code, where said code includes a high speed load handler application for controlling I/O, DMA, the host bus, a system bus and
at least one communications port;
a processing unit coupled to said memory for executing said code;
a plurality of specialized processors; and
a protocol adapter coupled to said processing unit, and adapted to couple to said host bus, for communicating with said host computer.

9. An adapter card according to claim 8, wherein said processing unit is adapted to distribute a load imposed on it by traffic to the various specialized processors.

10. An adapter card according to claim 8, wherein said card further includes a data encryption module.

11. An adapter card according to claim 8, wherein said card further includes a data compression module.

12. An adapter card according to claim 8, wherein said card further includes an SSL module.

13. An adapter card according to claim 8, wherein said card further includes a VPN module.

14. An adapter card according to claim 8, wherein said card further includes an SSL module and a VPN module.

15. An adapter card operatively coupled to an internal bus of a host computer including a host bus, for wirespeed security treatment of communications traffic, said adapter card comprising:
a network controller for communicating with clients on said network;
a memory for storing data and code, where said code includes a high speed load handler application for controlling I/O, DMA, the host bus, a system bus and at least one communications port;
a processing unit coupled to said memory for executing said code;
a protocol adapter coupled to said processing unit, and adapted to couple to said host bus, for communicating with said host computer;
wherein:
said adapter card further includes an IP stack.

16. An adapter card according to claim 15, wherein said card further includes a data encryption module.

17. An adapter card according to claim 15, wherein said card further includes a data compression module.

18. An adapter card according to claim 15, wherein said card further includes an SSL module.

19. An adapter card according to claim 15, wherein said card further includes a VPN module.

20. An adapter card according to claim 15, wherein said card further includes an SSL module and a VPN module.

21. An adapter card operatively coupled to an internal bus of a host computer including a host bus, for wirespeed security treatment of communications traffic, said adapter card comprising:
a network controller for communicating with clients on said network;
a memory for storing data and code, where said code includes a high speed load handler application for controlling I/O, DMA, the host bus, a system bus and at least one communications port;
a processing unit coupled to said memory for executing said code;
a plurality of specialized processors;
a protocol adapter coupled to said processing unit, and adapted to couple to said host bus, for communicating with said host computer;
wherein:
said processing unit is adapted to execute up to Layer 7 security functions.

22. An adapter card according to claim 21, wherein said processing unit is further adapter to execute FTP proxy functions; HTTP proxy functions; stateful packet inspection; packet filtering functions; encryption functions; SSL functions and VPN functions.

23. An adapter card according to claim 21, wherein said card further includes a data encryption module.

24. An adapter card according to claim 21, wherein said card further includes a data compression module.

25. An adapter card according to claim 21, wherein said card further includes an SSL module.

26. An adapter card according to claim 21, wherein said card further includes a VPN module.

27. An adapter card according to claim 21, wherein said card further includes an SSL module and a VPN module.

28. An adapter card according to claim 1, wherein a secure key is stored on a flash memory of said card in at least two separate parts.

29. An adapter card according to claim 8, wherein a secure key is stored on a flash memory of said card in at least two separate parts.

30. An adapter card according to claim 15, wherein a secure key is stored on a flash memory of said card in at least two separate parts.

31. An adapter card according to claim 21, wherein a secure key is stored on a flash memory of said card in at least two separate parts.

32. An adapter card according to claim 1, wherein said card is adapted to route a packet to another card by decrypting only the header of the packet.
